(19) United States
(12) Patent Application Publication
(10) Pub. No.: US 2003/0131757 A1
(43) Pub. Date: Jul. 17, 2003

(54) Hydrogenated starch hydrolysates with bimodal DP distribution

(76) Inventors: Marguerite Yang, Wilmette, IL (US); Anh Si Le, Geneva (CH); Normand Chabot, Rosemont, PA (US)

Correspondence Address: CONNOLLY BOVE LODGE & HUTZ LLP, 1220 MARKET STREET, P.O. BOX 2207, WILMINGTON, DE, 19899, US

(21) Appl. No.: 10/256,386

(22) Filed: Sep. 27, 2002

Related U.S. Application Data
(60) Provisional application No. 60/325,238, filed on Sep. 27, 2001.

(51) Int. Cl. C08L 3/02

(52) U.S. Cl. 106/215.5

(57) ABSTRACT

The present invention relates to a sweetener containing maltitol and hydrogenated starch hydrolysates (HSH). The sweetener of the invention is characterized in that it contains greater than 50 weight percent maltitol. The hydrogenated starch hydrolysates of the sweetener are characterized in that they contain a large amount of high DP hydrogenated polysaccharides.

### CLAIM OF PRIORITY

Priority is claimed under 35 U.S.C. § 119(e) from the U.S. Provisional Application Serial No. 60/325,238 filed on 27 Sep. 2001 which is herein incorporated by reference.

### BACKGROUND OF THE INVENTION

1. Field of the Invention

The present invention relates to a sweetener containing maltitol and hydrogenated starch hydrolysates (HSH). The sweetener of the invention is characterized in that it contains greater than 50 weight percent maltitol. The hydrogenated starch hydrolysates of the sweetener are characterized in that they contain a large amount of high DP hydrogenated polysaccharides.

The maltitol content of the sweetener provides favorable sweetness, viscosity, and water activity properties. Additionally, the high DP hydrogenated starch hydrolysates provide desirable stability, thickness, glass transition temperature, water-binding, and flavor properties. Furthermore, because the sweetener of the present invention contains greater than 50 weight percent maltitol, the United States Food and Drug Administration (FDA) permits the sweetener to be labeled as “maltitol” rather than “hydrogenated starch hydrolysates” sweetener.

2. Description of the Related Art

Maltitol is a polyol that is produced from the catalytic hydrogenation of high maltose corn syrup. Maltitol has approximately 90 percent of the sweetness of sugar and is generally recognized to have a caloric value of about 2.1 kcal/g. Products sweetened with maltitol meet the FDA's definition of “no sugar added” or “sugarless.” These properties allow maltitol to be used as a reduced-calorie sweetener in the United States. Maltitol is relatively slowly absorbed by the human digestive system, yet has a Taxation threshold that is about two times that of sorbitol. Maltitol also has a heat of solution comparable to sucrose, making it a popular sugar-free substitute sweetener. Maltitol is commonly used in candies, chewing gum, chocolates, jams and jellies, and frozen desserts.

Maltitol has a pleasant sweet taste and because maltitol has a relative sweetness value of 90, for most applications there is no need to adjust the sweetness. Unlike sorbitol, maltitol does not exhibit a strong cooling effect. Maltitol also has very good heat stability, which means that it can be handled at high temperature without decomposition or color formation. Due to the nature of maltitol and the virtual absence of reducing sugars, maltitol can be concentrated to very high dry substance levels without unwanted discoloration or browning reactions. Maltitol also has excellent humectancy capacity due to its hygroscopic character.

Hydrogenated starch hydrolysate (“HSH”) is a class of polysaccharides that includes hydrogenated glucose syrups, maltitol syrups, and sorbitol syrups, and is found in a wide variety of foods. Hydrogenated maltodextrins are also within the class of HSH polysaccharides. HSH serves a number of functional roles, including use as bulk sweeteners, viscosity or bodying agents, humectants, crystallization modifiers, cryoprotectants and rehydration aids. They also can serve as sugar-free carriers for flavors, colors and enzymes.

Hydrogenated starch hydrolysates are produced by the partial hydrolysis of corn, wheat, or potato starch with the subsequent hydrogenation of the hydrolysate at high temperature under pressure. The end product is an ingredient composed of sorbitol, maltitol, and higher hydrogenated saccharides. By varying the conditions and extent of the hydrolysis, the relative occurrence of various mono-, di-, oligo- and polymeric hydrogenated saccharides in the resulting product can be obtained. Therefore, a wide range of polyols that can satisfy varied requirements with respect to different levels of sweetness, viscosity and humectancy can be produced.

Hydrogenated mono-, di-, oligo- and poly-saccharides are characterized by the degree of polymerization (DP) after hydrogenation. Hydrogenated monosaccharides have a DP=1. Hydrogenated disaccharides have a DP=2. Hydrogenated tri-, quat-, penta-, hexa-, hepta-, octa-, nona-, and deca-saccharides have DPs of 3, 4, 5, 6, 7, 8, 9, and 10, respectively. Hydrogenated undeca- and greater saccharides have DPs of 11 or greater. The DP may be determined by routine HPLC analysis.

Generally, the term hydrogenated starch hydrolysate can correctly be applied to any polyol produced by the hydrogenation of the saccharide products of starch hydrolysis. In practice, however, certain polyols such as sorbitol, mannitol, and maltitol are referred to by their common chemical names. “Hydrogenated starch hydrolysate” is more commonly used to describe the broad group of polyols that contain substantial quantities of hydrogenated oligo- and polysaccharides in addition to any monomeric or dimeric polyols (sorbitol/mannitol or maltitol, respectively).

U.S. Pat. No. 5,629,042 to Serpelloni et al., which is hereby incorporated by reference, discloses a sugarless boiled sweet containing a water crystallizable polyol and carbohydrates, e.g., saccharides. The boiled sweet has a water content greater than three percent and a glass transition temperature greater than or equal to 38° C., the glass transition temperature (T_{g}) being measured at a water content of about 3.2 percent.

U.S. Pat. No. 4,248,945 to Stroz et al., which is hereby incorporated by reference, shows hydrogenated starch hydrolysates having total solids contents of about 72 to 80 weight percent. Based on the dry hydrogenated starch hydrolysates, the total solids contents consist of about 4 to 20 weight percent sorbitol (hydrogenated monosaccharide), 20 to 65 weight percent hydrogenated disaccharides (e.g., maltitol), 15 to 45 weight percent tri- to hepta-hydrogenated oligosaccharides, and 10 to 35 weight percent hydrogenated polysaccharides higher than hepta.

U.S. Pat. No. 4,445,938 to Verwaerde et al., which is hereby incorporated by reference, discloses dry hydrogenated starch hydrolysates consisting of, based on total solids content, less than 14 weight percent of hydrogenated monosaccharides, e.g., sorbitol, less than 35 weight percent of hydrogenated disaccharides, e.g., maltitol, 12 to 18 weight percent of hydrogenated trisaccharides, between 42 and 70 weight percent of hydrogenated quat- to deca-oligosaccharides, and less than 32 weight percent of hydrogenated polysaccharides greater than deca. The Verwaerde composition provides a more stable hydrogenated starch hydrolysate than one which has 15.5 or 30.0 weight percent of hydrogenated quat- to deca- oligosaccharides.

### SUMMARY OF THE INVENTION

The object of the present invention is to provide a sweetener having the beneficial properties of maltitol syrups and the beneficial properties of high-DP hydrogenated starch hydrolysate (HSH) syrups. It is an object of the invention to provide a sweetener is that contains greater than 50 weight percent maltitol. Another object of the invention is that the HSH has a relatively large amount of high DP polysaccharides, i.e., at least 8.5, preferably at least 9.0, and more preferably, at least 9.5 percent by weight of polysaccharides having a degree of polymerization (DP) greater than or equal to 11. A further object of the invention is that the sweetener has less than 1 percent by weight of polysaccharides having a DP of 9 or 10.

The sweetener of the present invention is further characterized by its flow, humectancy, water activity, sweetness, adhesion, water absorption, and flavor properties. These and other objects and advantages of the present invention can be appreciated by referring to the following description and claims or may be learned by the practice of this invention.

### DETAILED DESCRIPTION OF THE INVENTION

The objective of the invention is to provide a sweetener comprising maltitol and hydrogenated starch hydrolysates (HSH), wherein the maltitol content of the syrup is greater than 50 weight percent. In a preferred embodiment of the invention, the hydrogenated starch hydrolysates contain a large amount of long-chain polysaccharides having a DP value of greater than 11.

The inventors have unexpectedly found that the addition of high DP hydrogenated starch hydrolysates to high maltitol content syrup provides a low calorie sweetener having beneficial thickening, water activity, adhesion, stickiness reduction, and glass transition temperature (T_{g}) properties. Regarding water activity, the inventors have also observed that the sweetener of the present invention maintains a low water activity despite the addition of high DP HSH. To prevent growth of biological contaminants, it is necessary to maintain a water activity between about 0.70 and 0.86. The inventors have observed water activity values of from 0.81 to 0.84 in syrups embodying the sweetener of the present invention.

The present invention can be prepared in any of the following three ways. First, one can blend a maltitol syrup with a high-DP HSH syrup. Second, one can blend maltitol syrup with hydrogenated low-DE maltodextrin syrup, that is, hydrogenated maltodextrins having an approximate dextrose equivalent (DE) from about 4 to 18. Third, one can blend maltose syrup with low-DE maltodextrin to form a mixture and then hydrogenate the mixture. While the invention can be successfully carried out with any of the above methods, the inventors currently prefer using either of the post-hydrogenation blending methods (the first and second methods) for economical reasons. Additionally, it is a currently preferred that the components to make the invention be in liquid form.

The term high-DP HSH is directed to those sweeteners according to the invention that are prepared from the combination of maltitol syrup and HSH. This high-DP HSH for use in such products has the following DP distribution shown in Table 1, as determined by routine HPLC analysis.

TABLE 1
DP Range of Hydrogenated Starch Hydrolysates for use in the invention

| | Preferred | More Preferred | Most Preferred |
|---|---|---|---|
| DP | (wt.-% of syrup) | (wt.-% of syrup) | (wt.-% of syrup) |
| 1 + unknown | <8 | 2.6-7.7 | 2.8-3.7 |
| 2 | <41 | 21.4-40.1 | 25.8-34.3 |
| 3 | <15 | 8.9-13.6 | 10.4-12.2 |
| 4-10 | <30 | 16.0-29.3 | 24.5-29.3 |
| 11 or more | 14-38 | 22.5-37.1 | 22.5-29.2 |

The weight percents of the various saccharides in the hydrogenated starch hydrolysate syrups shown in Table 1 are based on the solids content in the syrups, i.e., they are not based on the total weight of the syrup; the weight of the water is excluded.

The first method of preparing the claimed invention involves blending a maltitol syrup with a HSH syrup. In a preferred embodiment, the maltitol syrup is MALTISWEET 3145 (a product of SPI Polyols, Inc., New Castle, Del.) and the HSH is STABILITE 1 or STABILITE 2 (both products and trademarks of INNOVA LLC, a joint-venture of SPI Polyols, Inc., New Castle, Delaware and Grain Processing Corp., Muscatine, Iowa). The preferred STABILITE HSH are disclosed in Le, U.S. patent application Ser. No. 09/276,014 (hereinafter “Le”), which is hereby incorporated by reference.

The second method of preparing the claimed invention involves blending maltitol syrup with hydrogenated maltodextrin. In a preferred embodiment, the maltitol syrup is MALTISWEET 3145 and the hydrogenated maltodextrin is HM040, HM 100, HM 150, or HM180 (all products of Innova LLC, Muscatine, Iowa). In another preferred embodiment, the maltitol syrup is HYSTAR® 5875 (a product and trademark of SPI Polyols Inc., New Castle, Del.) having 58 weight percent maltitol and 75 weight percent solids.

Maltodextrins are produced from the hydrolysis of starch. They generally have a dextrose equivalent (DE) between 1 and 20. The DE is a measurement of the reducing power of a starch hydrolysis product expressed as a percentage of the reducing power of the same weight of D-glucose. Although traditionally determined by titration, the DE may be determined by cryoscopy (depression of freezing point). The higher the DE, the lower the number average molecular weight of the product. The maximum possible DE is 100, i.e., pure dextrose. Maltodextrins are usually produced by the action of the enzyme α-amylase on gelatinised starch. Maltodextrin contains a range of nutritive non-sweet polysaccharides with a distribution of molecular weights where the anhydroglucose units are linked predominantly by 1,4 bonds. The commercial product is usually supplied as a free flowing spray-dried powder.

The hydrogenation of maltodextrin is disclosed in Barressi, et al. WO 99/36442, which is herein incorporated by reference. For example, 10 DE maltodextrin (MALTRIN M100, Grain Processing Corporation, Muscatine, Iowa) is hydrogenated by dissolving the maltodextrin powder in water to form a 55 weight percent solids solution. The solution is charged to a reactor with 5 percent Raney nickel (solids basis) as the hydrogenation catalyst. The reactor is then pressurized with hydrogen to 500 psi, heated to 130° C., and stirred. The reactor is maintained at this temperature and pressure until sampling shows that the reducible sugar has been converted to polyol. The reaction time is typically between 4 to 12 hours, depending on the size and configuration of the reactor used. When the reaction is completed, the stirring is stopped and the catalyst is allowed to settle. The hydrogenated maltodextrin reaction product is then decanted and filtered to remove fines. The filtered reaction product is next ion-exchanged through a strong cation and strong base anion using methods well known in the art. Finally, the reaction product is evaporated to about 60 to 70 weight percent solids for storage.

The third method of preparing the claimed invention involves blending low-DE maltodextrins with maltose syrup and then hydrogenating the mixture. In a preferred embodiment, the maltose syrup is ADVANTOSE crystalline maltose (a product of SPI Polyols, New Castle, Del.) dissolved in water to make a 50 percent syrup. In the same preferred embodiment, the low DE maltodextrin is MALTRIN M040, MALTRIN M100, MALTRIN M150, or MALTRIN M180 (all products of Grain Processing Corporation, Muscatine, Iowa, having approximate DE values of 4, 10, 15, and 18 respectively). Additional details regarding the MALTRIN products used in the present invention can be found in Baressi et al., WO 99/36442. In this embodiment, the hydrogenation of the maltose and low DE maltodextrin mixture is according to the method described above.

The following examples are provided to better understand the invention but not to limit the scope of the invention.

### EXAMPLE 1

### Maltisweet 3145 Blended with Stabilite 1

The following eight examples were prepared. To prepare each of the examples, the components were combined in a pan and mixed. The average DP distribution of each of the eight examples, as measured by HPLC analysis, is shown in TABLE 1-A.

TABLE 1-A
Average DP Distribution of MALTISWEET 3145 and
STABILITE I blends.

| Ratio of | | | | | | | | |
|---|---|---|---|---|---|---|---|---|
| STABILITE 1 | | | | | | | | |
| to MALTI- | | | | | | | | |
| SWEET 3145 | | | | | | | | |
| (percent/ | | | | | | | | |
| percent) | 30/70 | 35/65 | 40/60 | 45/55 | 50/50 | 55/45 | 60/40 | 65/35 |
| DP 11+ | 8.00 | 8.84 | 9.68 | 10.52 | 11.36 | 12.20 | 13.04 | 13.88 |
| DP 10 | 0.16 | 0.18 | 0.21 | 0.24 | 0.26 | 0.29 | 0.32 | 0.34 |
| DP 9 | 0.34 | 0.39 | 0.45 | 0.51 | 0.56 | 0.62 | 0.68 | 0.73 |
| DP 8 | 0.76 | 0.83 | 0.90 | 0.96 | 1.03 | 1.10 | 1.17 | 1.24 |
| DP 7 | 1.91 | 2.10 | 2.30 | 2.49 | 2.69 | 2.88 | 3.08 | 3.28 |
| DP 6 | 2.31 | 2.53 | 2.74 | 2.96 | 3.17 | 3.39 | 3.60 | 3.82 |
| DP 5 | 3.09 | 3.15 | 3.22 | 3.28 | 3.34 | 3.40 | 3.47 | 3.53 |
| DP 4 | 2.67 | 2.74 | 2.61 | 2.88 | 2.96 | 3.03 | 3.10 | 3.17 |
| DP 3 | 15.91 | 15.77 | 15.64 | 15.51 | 15.38 | 15.25 | 15.12 | 14.98 |
| Maltitol | 58.20 | 56.85 | 55.49 | 54.14 | 52.78 | 51.43 | 50.07 | 48.72 |
| Mannitol | 0.22 | 0.22 | 0.21 | 0.20 | 0.19 | 0.18 | 0.17 | 0.17 |
| Sorbitol | 4.07 | 4.13 | 4.20 | 4.26 | 4.32 | 4.38 | 4.45 | 4.51 |

In this example, the inventors found that the 65/35 blend did not have greater than 50 percent maltitol content, however, the remaining blends did have the necessary maltitol content.

### EXAMPLE 2

### Maltitol Blended with Hydrogenated Maltodextrin

The following six examples embodying the invention were prepared. To prepare each of the examples, the components, shown in TABLE 2-A, were combined in a pan and heated over an open flame until all the solids dissolved.

TABLE 2-A
Composition of Syrups A, B, C, D, E, and F.

| | | | | MALTI- | HYSTAR | |
|---|---|---|---|---|---|---|
| | | | | SWEET | 5875 [58 | |
| | | | | 3145 [65 | wt % | |
| | | | | wt % | maltitol | |
| | | | | maltitol and | and 75% | |
| | HM180 | HM100 | HM040 | 75% solids] | solids] | Water |
| | (wt %) | (wt %) | (wt %) | (wt %) | (wt %) | (wt %) |
| Syrup A | 10.5 | — | — | 84.6 | — | 4.9 |
| Syrup B | — | 10.5 | — | 84.6 | — | 4.9 |
| Syrup C | — | — | 10.5 | 84.6 | — | 4.9 |
| Syrup D | 10.5 | — | — | — | 84.6 | 4.9 |
| Syrup E | — | 10.5 | — | — | 84.6 | 4.9 |
| Syrup F | — | — | 10.5 | — | 84.6 | 4.9 |

Each mixture was then cooled and water was added to bring the syrup back to the original weight (75% solids). Six example syrups were prepared: Syrup A (MALTISWEET 3145 and HM180), Syrup B (MALTISWEET 3145 and HM100), Syrup C (MALTISWEET 3145 and HM040), Syrup D (HYSTAR 5875 and HM100), Syrup E (HYSTAR 5875 and HM100), and Syrup F (HYSTAR 5875 and HM040).

The average DP distribution of the individual components to make the six examples, as measured by HPLC analysis, is shown in TABLE 2-B. The average DP distribution of each of the six examples, as measured by HPLC analysis, is shown in TABLE 2-C.

TABLE 2-B
Average DP Distribution of Components of
Syrups A, B, C, D, F, and F.

| | | | | MALTISWEET | HYSTAR |
|---|---|---|---|---|---|
| | HM180 | HM100 | HM040 | 3145 | 5875 |
| DP 11+ | 40.84 | 62.10 | 85.00 | 2.95 | 8.42 |
| DP 10 | 2.04 | 2.50 | 1.70 | 0.00 | 0.00 |
| DP 9 | 2.66 | 3.10 | 1.80 | 0.00 | 0.00 |
| DP 8 | 4.17 | 4.50 | 2.00 | 0.34 | 1.49 |
| DP 7 | 1.23 | 6.80 | 2.40 | 0.73 | 3.06 |
| DP 6 | 11.90 | 5.70 | 1.80 | 1.03 | 1.94 |
| DP 5 | 6.13 | 3.40 | 1.30 | 2.71 | 2.21 |
| DP 4 | 6.49 | 3.80 | 1.40 | 2.23 | 1.79 |
| DP 3 | 8.40 | 4.40 | 1.40 | 16.70 | 14.02 |
| Maltitol | 5.81 | 2.90 | 0.90 | 66.34 | 59.44 |
| Mannitol | 0.00 | 0.00 | 0.00 | 0.27 | 0.00 |
| Sorbitol | 0.70 | 0.80 | 0.30 | 3.69 | 6.97 |

TABLE 2-C
Average DP Distribution of Syrups A, B, C, D, E, and F

| | Syrup A | Syrup B | Syrup C | Syrup D | Syrup E | Syrup F |
|---|---|---|---|---|---|---|
| DP 11+ | 9.53 | 11.83 | 11.16 | 11.85 | 14.16 | 16.51 |
| DP 10 | 0.22 | 0.38 | 0.17 | 0.22 | 0.29 | 0.18 |
| DP 9 | 0.28 | 0.47 | 0.18 | 0.28 | 0.35 | 0.19 |
| DP 8 | 0.90 | 0.97 | 0.51 | 1.77 | 1.81 | 1.54 |
| DP 7 | 1.99 | 1.64 | 0.90 | 3.82 | 3.47 | 2.99 |
| DP 6 | 2.35 | 1.49 | 1.10 | 2.99 | 2.38 | 1.93 |
| DP 5 | 2.57 | 2.82 | 2.57 | 2.62 | 2.32 | 2.11 |
| DP 4 | 2.48 | 2.47 | 2.15 | 2.29 | 1.99 | 1.75 |
| DP 3 | 15.55 | 14.85 | 15.17 | 13.43 | 12.98 | 12.69 |
| Maltitol | 60.56 | 56.82 | 59.79 | 53.77 | 53.40 | 53.25 |
| Mannitol | 0.11 | 0.23 | 0.24 | 0.00 | 0.00 | 0.00 |
| Sorbitol | 3.11 | 3.26 | 3.35 | 6.31 | 6.26 | 6.26 |

The water activity for each of the six examples was also measured and is shown in TABLE 2-D.

TABLE 2-D. Water Activity of Syrups A, B, C, D, E, and F.

| | Water Activity (%) |
|---|---|
| Syrup A | 81.8 |
| Syrup B | 81.7 |
| Syrup C | 83.6 |
| Syrup D | 80.8 |
| Syrup E | 81.8 |
| Syrup F | 83.4 |

The inventors expect successful applications for this invention in hard and soft candies, syrups, bakery products such as, but not limited to, pastries and cookies, granola, energy bars, icings, and savory sauces. The following examples are applications of the invention.

### EXAMPLE 3

### Sugar-Free Hard Candy

| Ingredients | Percent |
|---|---|
| Invention | 97.5-99.0 |
| Citric Acid (50% solution) | 0.5-1.0 |
| Flavor (heat stable) | 0.2-1.0 |
| Color (heat stable) | q.s. |

From 97.5 to 99.0 percent of the invention was cooked in a precooker to 250° F. to 270° F. and then transferred to a vacuum cooker with 100 to 110 psi steam and 27 to 29 inches of vacuum for 5 to 8 minutes. Open fire cooking, or cooking up to temperature and then pulling a vacuum will not reduce the candy moisture to less than 0.5 percent. To prevent cold flow, the final moisture content for the candy should be less than 0.5 percent. After cooking, the batch is cooled using tempered, cool water circulating in the jacket of a cooling table. During cooling, 0.5 to 1.0 percent citric acid is added, 0.2 to 1.0 percent heat-stable flavoring is added, and colorant is added. Additional ingredients may also be added at this time. The cooled candy, while still pliable, is ready to be formed. The candy will completely set in about 5 to 10 minutes. Once set, the candy is stored at a relative humidity of 35 to 40 percent prior to packaging. The packaging should provide the maximum moisture protection as the product is sensitive to moisture.

### EXAMPLE 4

### Sugar-Free Icing

| Ingredients | Percent |
|---|---|
| AMALTY MR-50 Crystalline Maltitol | 53 |
| Invention | 5 |
| Shortening/Emulsifier | 8 |
| Unsweetened chocolate | 17.2 |
| Flavor | 0.4 |
| Water | 16.4 |

In a saucepan, 16.4 weight percent water, 8 weight percent shortening/emulsifier, and 5 weight percent of the present invention were combined and heated until boiling. In a Hobart mixer, 53 weight percent AMALTY® MR-50 crystalline maltitol (a product of Towa Chemical Industry Company, Ltd.) and 17.2 weight percent unsweetened chocolate was sifted into the mixing bowl. These ingredients were mixed with a paddle attachment on speed no. 1 and the boiling water mixture was added. Then the mixture was blended until smooth. At this point 0.4 percent flavor was blended into the icing.

### EXAMPLE 5

### Granola Bar

| Ingredients | Percent |
|---|---|
| Vegetable Oil | 8.33 |
| Invention | 18.17 |
| Vanilla | 0.50 |
| Eggs | 8.11 |
| Flour (whole wheat) | 15.29 |
| Cinnamon | 0.29 |
| Baking Powder | 0.23 |
| Salt | 0.18 |
| Oats | 12.51 |
| Crisp Rice Cereal | 6.95 |
| Chopped Nuts | 14.71 |
| Optional Ingredients | 14.71 |
| (raisins, currants, chocolate | |
| chips, peanut butter chips, | |
| chopped dried fruit, etc.) | |

In a large mixing bowl, the oil, invention, vanilla, and eggs were combined and mixed well with a whisk. Then flour, cinnamon, baking powder, and salt were added and mixed well. Using a spatula, the oats, cereal, and nuts, fruit, or baking chips were added to the mixture and thoroughly blended. The mixture was then placed into a 9″×13″ pan that was coated with cooking spray. The mixture was pressed evenly into the bottom of the pan. To obtain chewy bars, the mixture should be baked at 350° F. for 20 to 30 minutes until lightly browned at the edges. To obtain crunch bars, the mixture should be baked at 300° F. for 40 to 50 minutes until the surface is golden brown all over. After baking, the mixture should be cooled completely and cut into 16 bars by slicing through the middle lengthwise and slicing seven time cross wise.

### EXAMPLE 6

### Puffed Rice Snacks

| | |
|---|---|
| Ingredients | Percent |

Part A

| | |
|---|---|
| Invention | 44.94 |
| Frappe | 22.47 |
| 225 Bloom Gelatin | 11.23 |
| Vanilla Extract | 1.12 |
| Water | 16.4 |

Part B

| | |
|---|---|
| Puffed Rice | 8.43 |
| Margarine | 11.81 |

To make part A, the invention syrup was heated to 250° F. to 270° F., depending on the desired texture. Then the syrup was cooled to 250° F. and gelatin (in solution) added. The mixture was then placed into a Hobart mixing bowl and whipped at high speed using a delta paddle. When the mixture reached 190° F., the vanilla was added and the whipping continued. When the mixture further cooled to 150° F. to 160° F., the frappe was added and the whipping continued unto the mixture became light and fluffy. The mixture was then allowed to cool. The margarine was then melted and mixed into part A. The puffed rice was blended into the mixture until evenly distributed. The mixture was then added to a 9″×13″ pan that was coated with non-stick cooking spray and pressed evenly into the bottom of the pan. The mixture was allowed to cool for 1 to 2 hours and then sliced.

### EXAMPLE 7

### Sports Bar (Chocolate)

| Ingredients | Percent |
|---|---|
| Invention | 34.67 |
| Sodium Caseinate | 10.25 |
| SUPRO PLUS 675 Soy Protein | 8.32 |
| (product of Protein Technologies International, St. Louis MO) | |
| Oat Bran | 13.90 |
| MALTRIN M100 Maltodextrin | 13.24 |
| Cocoa Powder | 6.67 |
| Puffed Rice | 6.00 |
| Brown Rice Flour | 1.52 |
| Glycerine | 0.67 |
| water | 4.76 |

The invention, glycerine, water, and MALTRIN M100 were blended and heated until clear. The remaining ingredients, except for the rice flour, were then dry blended and placed into a Hobart mixer. Setting the mixer on speed no. 1, the heated clear liquid mixture was poured over the dry blend and mixed until it formed a soft dough. The soft dough was then dusted with rice flour, rolled out, and either cut or extruded into bars.

### EXAMPLE 8

### 40:30:30 Bar

| Ingredients | Percent |
|---|---|
| Invention | 38.59 |
| SUPRO PLUS 675 Soy Protein | 15.69 |
| (product of Protein Technologies International, St. Louis MO) | |
| POWER PRO 80% Whey Protein Concentrate | 10.46 |
| (product of Land O' Lakes, St. Paul, MN | |
| Canola Oil | 7.85 |
| Applesauce | 7.66 |
| Calcium Caseinate | 6.97 |
| Dried Pecans, chopped | 4.36 |
| MALTRIN M180 Maltodextrin | 3.51 |
| Puffed Rice | 2.19 |
| Rolled Oats | 1.67 |
| Artificial Vanilla Flavor | 0.88 |
| Oat Bran | 0.18 |

The rolled oats, MALTRIN M180, soy protein, whey protein concentrate, calcium caseinate, oat bran, and puffed rice were blended in a Hobart mixer until well mixed. The invention and canola oil were mixed and heated to approximately 170° F. to 180° F. Once the invention and canola oil mixture reached the appropriate temperature, it was added to the dry ingredients in the Hobart mixer and mixed until well dispersed. Then the applesauce, vanilla flavor, and chopped pecans were added and mixed until well dispersed. Then the mixture was rolled out and cut or extruded into bars.

While the invention has been particularly shown and described with reference to preferred embodiments thereof, it will be understood by those skilled in the art that various changes in form and details may be made without departing from the spirit and scope of the invention as defined in the appended claims.

We claim:

1. A composition comprising maltitol and hydrogenated starch hydrolysates (HSH), wherein said composition comprises greater than 50 percent by weight maltitol, and wherein said composition comprises at least 8.5 percent by weight of polysaccharides having a degree of polymerization (DP) greater than or equal to 11.

2. The composition of claim 1, wherein said composition comprises less than 1 percent by weight of polysaccharides having a DP of 9 or 10.

3. The composition of claim 1, wherein said composition comprises at least 9.0 percent by weight of polysaccharides having a DP greater than or equal to 11.

4. The composition of claim 1, wherein said composition comprises at least 9.5 percent by weight of polysaccharides having a DP greater than or equal to 11.

5. The composition of claim 1 prepared by the combination of a maltitol syrup and a high-DP HSH syrup.

6. The composition of claim 5, wherein said high-DP HSH has the following DP distribution determined by HPLC analysis:
less than 8 wt % of the HSH has a DP=1 or unknown;
less than 41 wt % of the HSH has a DP=2;
less than 15 wt % of the HSH has a DP=3;
less than 30 wt % of the HSH has a DP=4 to 10; and
from 14 to 38 wt % of the HSH has a DP of 11 or more.

7. The composition of claim 1 prepared by the combination of a maltitol syrup and hydrogenated maltodextrin.

8. The composition of claim 7, wherein said hydrogenated maltodextrin is derived from a maltodextrin that having a dextrose equivalent (DE) of from about 4 to 18.

9. The composition of claim 1 prepared by the combination of low-DE maltodextrin with a maltose syrup and subsequently hydrogenating the combination.

10. The composition of claim 9, wherein said low-DE maltodextrin has a DE of from about 4 to 18.

11. The composition of claim 1, wherein said composition has a water activity of from about 0.81 to 0.84.
